(19) United States
(12) Patent Application Publication
(10) Pub. No.: US 2015/0226639 A1
(43) Pub. Date: Aug. 13, 2015

(54) METHOD OF INSPECTING WORN SURFACES OF CAMSHAFT LOBES

(71) Applicant: Caterpillar Inc., Peoria, IL (US)

(72) Inventors: Daniel T. Cavanaugh, Chillicothe, IL (US); Luis A. Vazquez, Peoria, IL (US); Adam W. Ostein, Corinth, MS (US)

(73) Assignee: Caterpillar Inc., Peoria, IL (US)

(21) Appl. No.: 14/696,512

(22) Filed: Apr. 27, 2015

(51) Int. Cl. G01M 13/02; G01S 17/08; F01L 1/047

(52) U.S. Cl. CPC G01M 13/02; F01L 1/047; G01S 17/08

(57) ABSTRACT

The present disclosure relates to a method for inspecting worn surface of camshaft lobes of a camshaft. The method includes providing a laser scanning device at a predetermined distance from the worn surface of the camshaft lobes, the laser scanning device being configured to scan and gather data. The method includes moving the laser scanning device along a reference axis parallel with an axis of rotation of the camshaft and repeating the scanning for each camshaft lobe of the camshaft. The method includes generating a set of data points for each camshaft lobe. The method further includes determining a maximum depth of the worn surface based on the set of data points. The method also includes selecting the camshaft lobes for a remanufacturing process, if the maximum depth of the worn surface for each measured camshaft lobe is less than or equal to a predefined tolerance limit.

### TECHNICAL FIELD

The present disclosure relates to a method of inspecting worn surfaces of camshaft lobes.

### BACKGROUND

Typically components of a machine such as, an internal combustion engine are subject to loads and abrasion during operation thereof. One such machine component, for example, a camshaft, which may experience loads from various components such as lifters, pushrods, bearings and rocker arms of the engine. Engine operation, especially if a long service interval has passed, subjects the contact surface of the camshaft to extended periods of loading and abrasion thereby causing wear.

The surface of the camshaft may be inspected and sorted before repairing or remanufacturing. For inspection, the surface is inspected by image comparison by an operator to determine whether the component can be ground undersized or if the damage is severe and the camshaft mat not be repaired.

For reference, U.S. Pat. No. 8,555,725 (the '725 patent) discloses a portable non-contact sensor system which includes a laser generator subsystem, a laser detector subsystem, and an analysis subsystem. The laser generator subsystem is configured to project a plurality of laser pulses at a surface of an object that is to be characterized. The laser detector subsystem is configured to receive return laser pulses from the object. The analysis subsystem is configured to analyze the received return pulses and characterize the object. However, a relative movement between the surface of the object and the non-contact sensor system may be required for detection. Since the sensor system of the '725 patent is hand-held, an accurate relative movement may not be possible.

### SUMMARY OF THE DISCLOSURE

In an aspect of the present disclosure a method of inspecting a camshaft for worn surfaces of camshaft lobes is provided. The camshaft has an axis of rotation. The method includes providing a laser scanning device at a predetermined distance from the worn surface of each of the camshaft lobes. The system includes the laser scanning device configured to scan and gather data related to the worn surface. The method further includes moving the laser scanning device along a reference axis parallel with the axis of rotation of the camshaft and repeating the scanning for each of the camshaft lobes of the camshaft. The method further includes generating a set of data points, via the laser scanning device. Further, each data point of the set of data points is indicative of a depth of a corresponding point on the worn surface relative to a reference surface. The method further includes determining a maximum depth of the worn surface based on the set of data points. The method further includes comparing the maximum depth of the worn surface to a predefined tolerance limit; and selecting the camshaft lobes for a remanufacturing process if the maximum depth of the worn surface for each measured camshaft lobe is less than or equal to the predefined tolerance limit.

Other features and aspects of this disclosure will be apparent from the following description and the accompanying drawings.

### BRIEF DESCRIPTION OF THE DRAWINGS

FIG. 1 is a partial sectional view of an exemplary engine showing a camshaft;

FIG. 2 is a perspective view of the camshaft of FIG. 1, showing worn portions located on the camshaft lobes;

FIG. 3 is a diagrammatic and illustrative view of a system for inspecting worn portions or surfaces of the camshaft lobes of FIG. 2, according to an embodiment of the present disclosure;

FIG. 4 is an enlarged view of the encircled portion 4-4 of FIG. 3;

FIG. 5 is a graphical representation showing a profile of the worn surface of the camshaft lobe shown in FIG. 4, according to an embodiment of the present disclosure; and

FIG. 6 is a flow chart of a method of inspecting the worn surfaces of the camshaft lobes, according to an embodiment of the present disclosure.

### DETAILED DESCRIPTION

Reference will now be made in detail to specific embodiments or features, examples of which are illustrated in the accompanying drawings. Wherever possible, corresponding or similar reference numbers will be used throughout the drawings to refer to the same or corresponding parts.

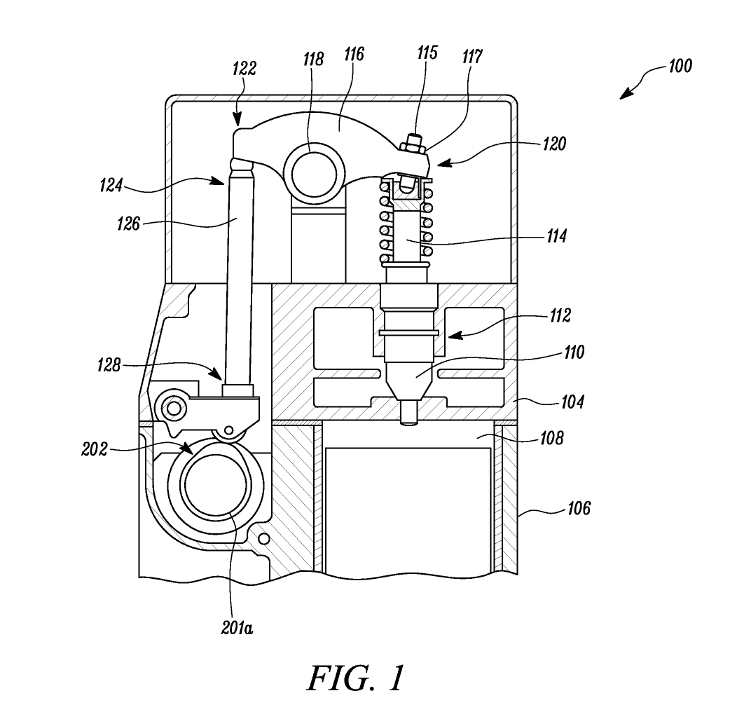

FIG. 1 illustrates a partial sectional view of an exemplary engine 100. The engine 100 may be any internal combustion engine used in various types of industries, for example, construction, transportation, mining and power generation. The engine 100 may also be used to power various types of machines, for example, excavators, loaders, dozers, mining trucks and electric generators.

The engine 100 includes a cylinder head 104 and a cylinder block 106. The cylinder block 106 is configured to define one or more cylinders 108. One cylinder 108 is shown in FIG. 1. Each cylinder 108 may include one or more intake valves (not shown) and one or more exhaust valves (not shown). The cylinder 108 further includes a fuel injector 110 disposed in the cylinder head 104. The fuel injector 110 includes a body 112 and a plunger 114 slidably disposed within the body 112 of the fuel injector 110. The plunger 114 is further coupled to a rocker arm 116 disposed over each of the cylinders 108.

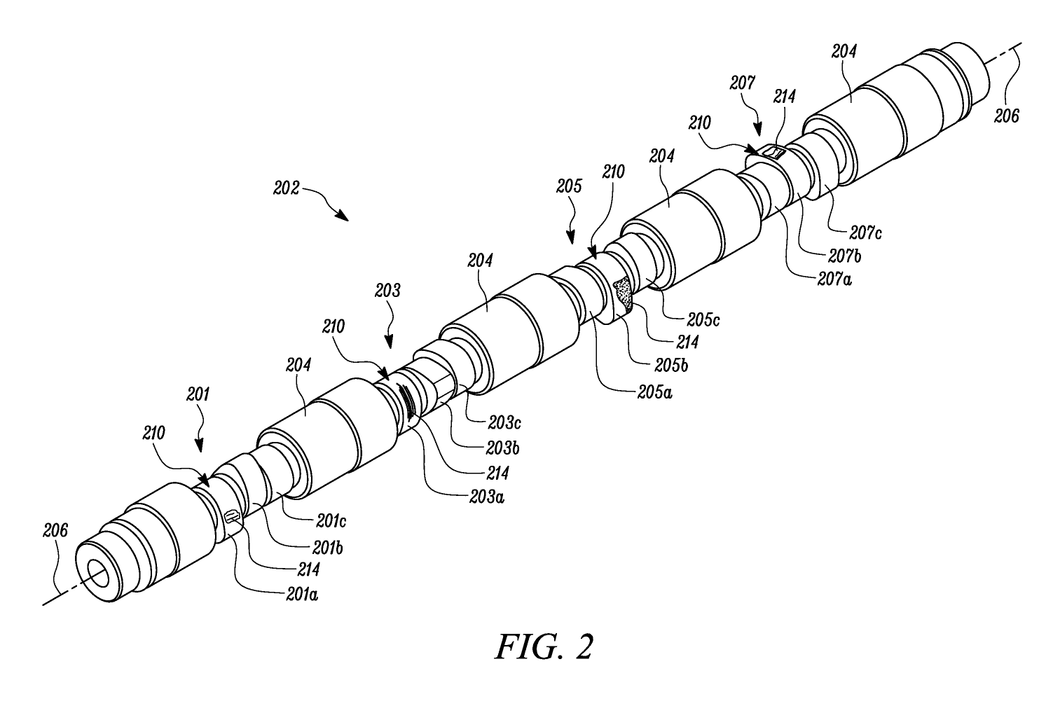

The rocker arm 116 is pivotally coupled to the cylinder head 104 via a shaft 118. The rocker arm 116 includes a first end 120 coupled to the plunger 114 of the fuel injector 110. In an example, the plunger 114 may be coupled to the first end 120 of the rocker arm 116 via a bolt 115 and a nut 117. Coupling between the plunger 114 and the rocker arm 116 may be adjusted tightening the bolt 115 and the nut 117 based on a movement of the plunger 114 within the body 112 of the fuel injector 110. The rocker arm 116 further includes a second end 122 opposite to the first end 120. The second end 122 is configured to engage with a top end 124 of a pushrod 126. A bottom end 128 of the pushrod 126 is configured to engage with a camshaft lobe 201a defined in a camshaft 202. The camshaft 202 is rotatably supported in the cylinder block 106. One of the camshaft lobes 201a is shown in FIG. 1. The pushrod 126 may ride against a profile defined by the camshaft lobe 201a. It may be contemplated that the camshaft 202 may include a plurality of the camshaft lobes (shown in FIG. 2) along a length thereof in order to actuate corresponding rocker arms 116 associated with the intake valves, the exhaust valves and the fuel injector 110 of each of the cylinders 108 of the engine 100.

FIG. 2 shows a perspective view of the camshaft 202. The camshaft 202 includes multiple sets 201, 203, 205, 207 of the camshaft lobes corresponding to each of the cylinders 108 of the engine 100. The set 201 includes individual camshaft lobes 201a, 201b and 201c for actuating the intake valves, the exhaust valves and the fuel injector 110 of the corresponding cylinder 108 of the engine. Similarly, the set 203 includes the camshaft lobes 203a, 203b and 203c. Further, the set 205 includes the camshaft lobes 205a, 205b and 205c. Moreover, the set 207 includes the camshaft lobes 207a, 207b and 207c. A bearing portion 204 is defined between each of the sets 201, 203, 205, 207 to rotatably support the camshaft 202 at various locations of the cylinder block 106.

The set 201 will be now described in detail for illustrative purposes. Each of the camshaft lobes 201a, 201b and 201c has a different profile specification corresponding to actuation of the intake valves, the exhaust valves and the fuel injector 110 during the operation of the engine 100. Each of the camshaft lobes 201a, 201b and 201c includes a base portion (not shown) which is circular in cross section. The camshaft 202 rotates about a rotation axis 206 defined by the base portion of the camshaft lobes 201a, 201b and 210c. In an embodiment, the camshaft lobe 201a is adapted to provide a lift to the push rod 126 (shown in FIG. 1) to actuate the corresponding rocker arms 116. Further, the camshaft lobe 201a may include a surface 210 adapted to define a line contact or a point contact with the bottom end 128 of the pushrod 126.

In an embodiment, each of the sets 201, 203, 205 and 207 may be substantially identical in design. However, each of the sets 201, 203, 205 and 207 may be rotated about the rotation axis 206 by an angle with respect to the adjoining set. In an example, the angle may be about 90 degrees. The camshaft 202, as described above, is purely exemplary in nature, and the camshaft 202 may have alternative configurations based on the type of engine.

Over the course of normal operation up to a first overhaul service event for the engine 100, the surface 210 of the camshaft 202 may develop worn or damaged portions therealong. Wear or damage may be further exacerbated if oil changes are neglected and the lubricant is allowed to break down leading to lack of lubricity or lubrication of the camshaft 202. Such operating conditions may cause excessive wear or scuffing of the surfaces 210 of each of the camshaft lobes of the sets 201, 203, 205 and 207, which may affect operation and replacement or reconditioning of the camshaft 202. Exemplary worn surface portions 214 is shown in FIGS. 2-4 to illustrate portions of the surfaces 210 which may be subject to scrutiny for repair as will be hereinafter described.

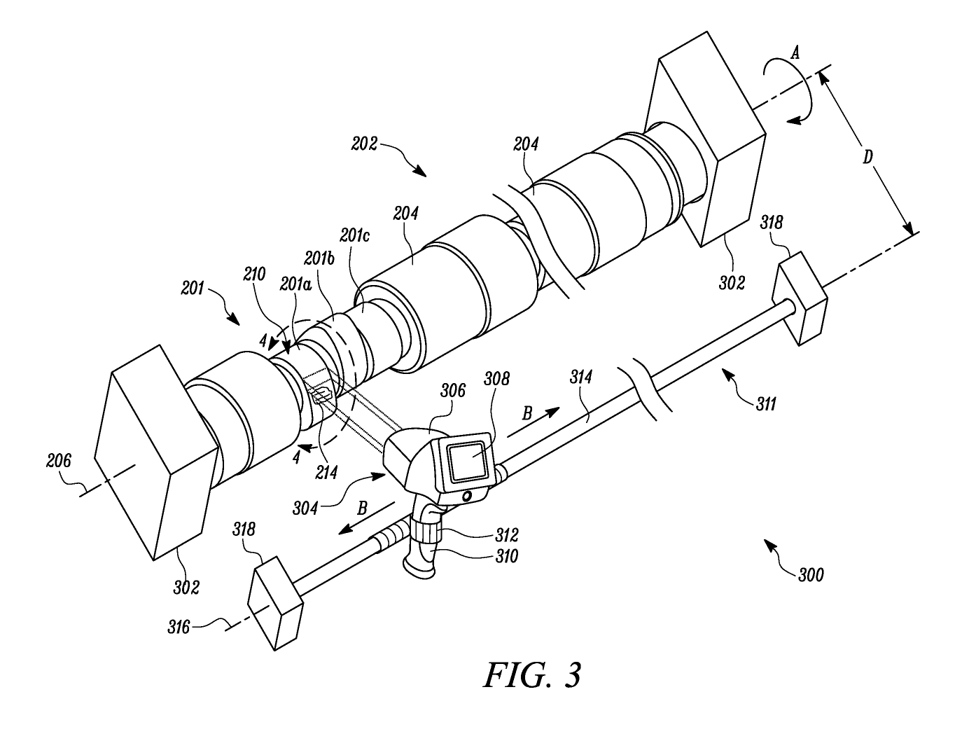

FIG. 3 illustrates a system 300 for inspecting the worn surface portions 214 of the camshaft lobes of each of the sets 201, 203, 205, 207, according to an embodiment of the present disclosure. For illustrative purposes, we have only shown the set 201 in FIG. 3. The system 300 includes a fixture 302 configured to rotatably support the camshaft 202 at both ends thereof. In an example, a motor (not shown) may be coupled at least one end of the camshaft 202 to rotate the camshaft 202 about the rotation axis 206, as indicated by an arrow ‘A’.

The system 300 further includes a laser scanning device 304 configured to inspect the worn surface portions 214 of the camshaft lobes of each of the sets 201, 203, 205, 207. The laser scanning device 304 includes a scanning head 306 that is configured to emit laser beam on the worn surface portions 214. The laser scanning device 304 further includes a display device 308 disposed behind the scanning head 306. The laser scanning device 304 further includes a handle 310 adapted to be engaged with the scanning head 306. The handle 310 is further detachably coupled to a carriage assembly 311. As shown in FIG. 3, the carriage assembly 311 includes a holding member 312 configured to be removably coupled to the handle 310 of the laser scanning device 304. The carriage assembly 311 further includes a rod member 314. In the illustrated embodiment, the holding member 312 is further slidably engaged with a rod member 314 such that the holding member 312 along with the laser scanning device 304 may be movable along a reference axis 316 defined by the rod member 314, as illustrated by arrows ‘B’. The carriage assembly 311 also includes a rod fixture 318 which retains the rod member 314 such that the reference axis 316 is parallel with and spaced from the rotation axis 206 by a distance ‘D’. The distance ‘D’ between the rotation axis 206 and the reference axis 316 may enable the laser scanning head 306 to be at a predetermined distance from the worn surface portions 214 of the camshaft lobes of the sets 201, 203, 205, 207. Further, the distance ‘D’ may be defined such that the laser scanning device 304 may detect the laser beams reflecting from the worn surface portions 214.

In an embodiment, the laser scanning device 304 may be temporarily fixed along the reference axis 316 in order to scan one of the camshaft lobes of the sets 201, 203, 205 and 207. For example, as illustrated in FIG. 3 the laser scanning device 304 may be temporarily fixed along the reference axis 316 in order to be aligned with the camshaft lobe 201a. The laser scanning device 304 may be moved along the reference axis 316 by sliding the holding member 312 along the rod member 314. In an embodiment, an actuator (not shown) may be configured to move the holding member 312 and temporarily fix the holding member 312 at a position along the reference axis 316. The camshaft 202 may be rotated about the rotation axis 206 once the laser scanning device is aligned with the camshaft lobe 201a such that the laser scanning device 304 may scan the worn surface portion 214 of the camshaft lobe 201a. Subsequently, the laser scanning device 304 may be moved along the reference axis 316 in order to align with the camshaft lobe 201c. The laser scanning device 304 may be then fixed in position and a scanning operation may be performed on the camshaft lobe 201c. The other camshaft lobes of the camshaft 202 may be scanned in a similar manner. In another embodiment, the laser scanning device 304 may be indexible to a plurality of temporarily fixed positions along the reference axis 316 corresponding to each of the camshaft lobes of the sets 201, 203, 205 and 207. For example, after performing a scanning operation of the camshaft lobe 201a, the holding member 312 may move to a subsequent indexed position corresponding to the camshaft lobe 201c. The actuator associated with the holding member 312 may perform the indexing movements of the holding member 312.

A method of inspecting the worn surface portion 214 includes placing the camshaft 202 on the fixture 302 along the rotation axis 206 such that the camshaft 202 may be rotated about the rotation axis 206. Further, the carriage assembly 311 provides the laser scanning device 304 at a predetermined distance from the worn surface portions 214.

The system 300 may further include a controller (not shown) configured to emit the laser beam via the scanning head 306 and receive signals indicative of the profile of the surface 210. In the illustrated embodiment, the controller is an integral part of the laser scanning device 304. Further, the controller may be configured to be in communication with the display device 308 to display an output generated based on the signals received from the surface 210. In another embodiment, the controller may be separately communicated with the scanning head 306 of the laser scanning device 304. In such case, the controller may be disposed proximate to the location of the scanning head 306 of the laser scanning device 302. In an example, the laser scanning device 304 may also have a control switch that may trigger the laser beam during the inspection.

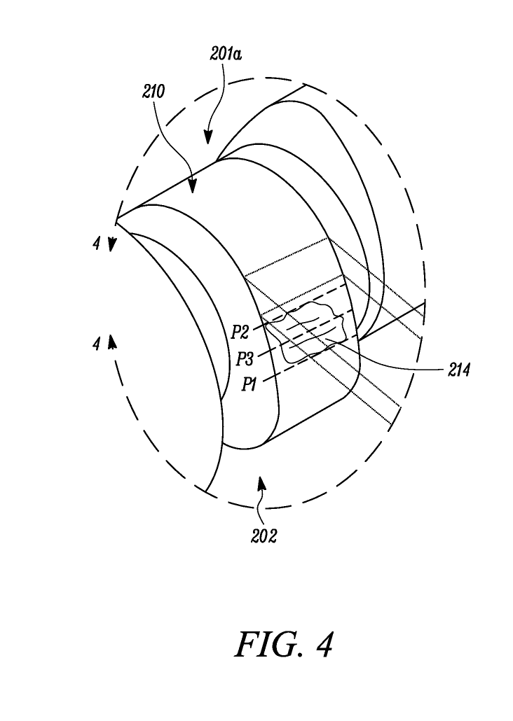

The surface 210 is defined by a set of data points generated via the laser scanning device 304. FIG. 4 shows an enlarged view of an encircled portion 4-4 of FIG. 3. The worn surface portion 214 of the camshaft lobe 201a is represented by multiple data points P1, P2 and P3.

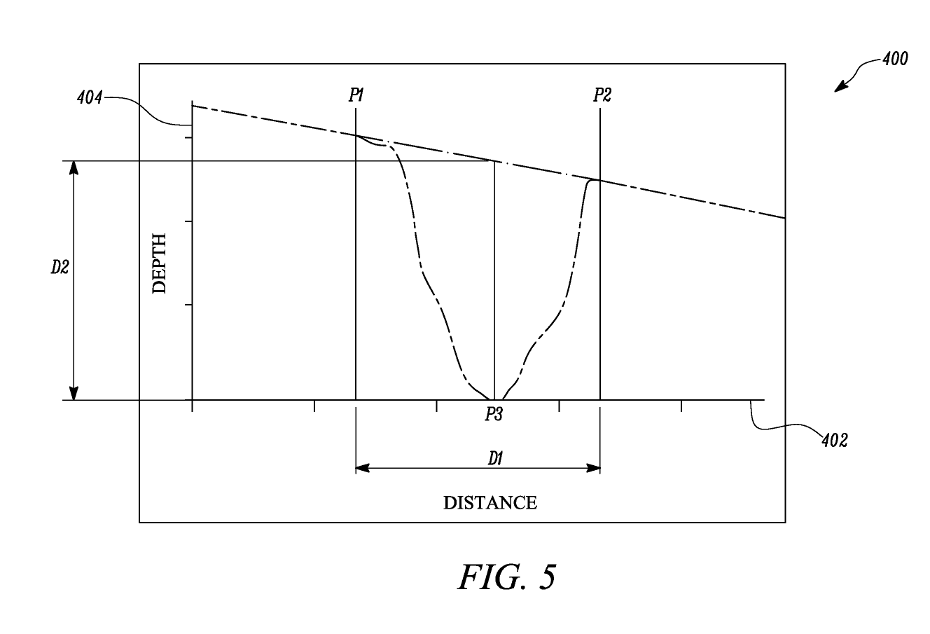

FIG. 5 illustrates a graphical representation showing a profile of the worn surface portion 214 of the camshaft 202. In an embodiment, the profile of the worn surface portion 214 is shown in a Two Dimensional (2D) graph 400. In other embodiments, a Three Dimensional (3D) graph may be used to represent a 3D view of the profile of the worn surface portion 214. The 2D graph 400 includes horizontal axis 402 representing a distance defined along a circumference defined by the surface 210 of the camshaft lobe 201a. Further, the 2D graph 400 includes a vertical axis 404 representing a depth of the worn surface portion 214 defined with reference to the surface 210 of the camshaft lobe 201a. The profile of the worn surface portion 214 of the camshaft lobe 201a is represented with reference to the set of data points. Each of the data points may be determined based on the signals received by the laser scanning device 304 from the worn surface portion 214 of the camshaft lobe 201a.

As shown in FIG. 4 and FIG. 5, the data point P1 may indicate a leading edge of the worn surface portion 214 and the data point P2 may indicate a trailing edge of the worn surface portion 214. A length measured between the data points P1, P2 may correspond to a distance D1 defined along the horizontal axis 402. Further, the data point P3 indicates a depth of the worn surface portion 214 defined with reference to the surface 210 of the camshaft lobe 201a. As shown in FIG. 5, the depth measured at the data point P3 with reference to the surface 210 of the camshaft lobe 201a is indicated as ‘D2’.

The data collected after scanning the worn surface portion 214 is then compared to a predefined tolerance limit. In an embodiment, the predefined tolerance limit may be stored in the controller, such that the data points corresponding to the worn surface portion 214 may be compared with the predefined tolerance limit stored in the controller. In another embodiment, the data points defined by the laser scanning device 304 may be compared with the predefined tolerance limit manually. For example, if the worn surface portion 214 has the depth ‘D2’ greater than the predefined tolerance limit, then the camshaft 202 is considered as scrap. If the depth ‘D2’ of the worn surface portion 214 is less than or equal to the predefined tolerance limit, then the camshaft 202 may be remanufactured to define a new profile for the camshaft lobes 201a. In an embodiment, the controller may give an alert signal if the depth ‘D2’ of the worn surface portion 214 is greater than the predefined tolerance limit. The camshaft 202 may be remanufactured by various machining operations including, but not limited to, grinding, turning, a milling operation. The difference in the displacement of the pushrod 126 (shown in FIG. 1) due to the new profiled of the camshaft lobe 201a may be adjusted while assembling the rocker arm 116 by the bolt 115 and the nut 117. A similar operation may be carried out for the other camshaft lobes of the sets 201, 203, 205 and 207. Further, a similar operation may also be carried out to determine wear of the bearing portions 214 of the camshaft 202.

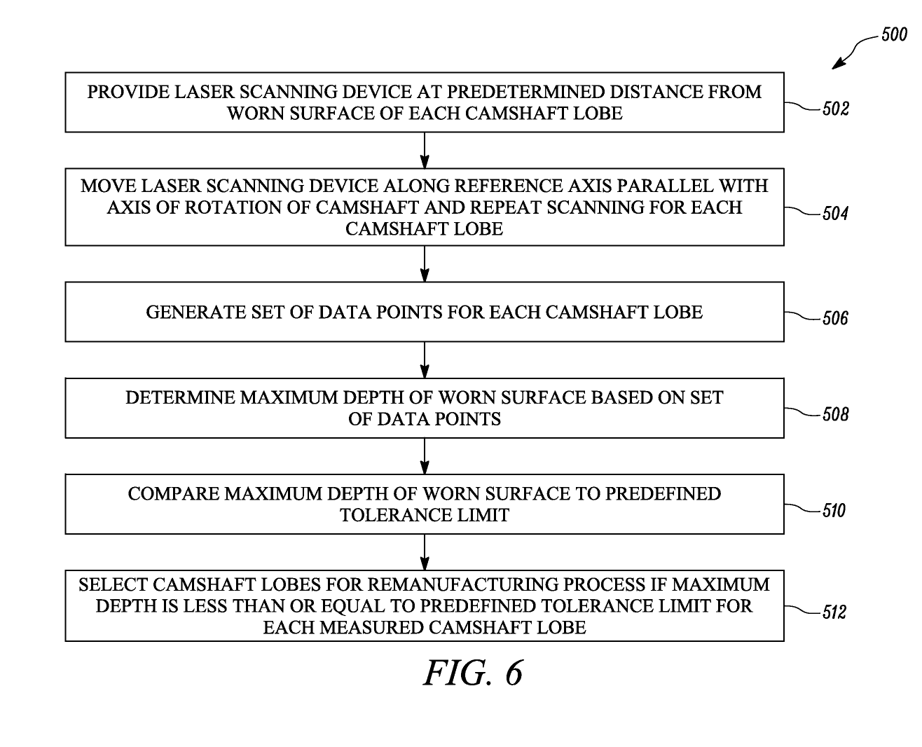

FIG. 6 illustrates a method 500 for inspecting the worn surface portion 214 of the camshaft lobes of the sets 201, 203, 205 and 207, according to an embodiment of the present disclosure. At step 502, the method 500 includes providing the laser scanning device 304 at the predetermined distance from the worn surface portion 214 of each of the camshaft lobes of the camshaft 202. In the illustrated embodiment of FIG. 3, the laser scanning device 304 is disposed at the predetermined distance from the camshaft lobe 201a. The laser scanning device 304 is configured to scan and gather data related to the worn surface portion 214. The carriage assembly 311 may enable the laser scanning device 304 to be disposed at the predetermined distance from the worn surface 214 of each of the camshaft lobes of the sets 201, 203, 205 and 207.

At step 504, the method 500 further includes moving the laser scanning device 304 along the reference axis 316 parallel with the axis of rotation 206 of the camshaft 202 and repeating the scanning for each of the camshaft lobes of the camshaft 202. As described above with reference to FIG. 3, the holding member 312 may enable the laser scanning device 304 to be temporarily fixed at a plurality of positions along the reference axis 316 in order to perform scanning of each of the camshaft lobes of the camshaft 202. Further, the camshaft 202 may be rotated about the rotation axis 206 to facilitate the scanning operation.

At step 506, the method 500 includes generating the set of data points P1, P2, P3, via the laser scanning device 304, for each of the camshaft lobes of the sets 201, 203, 205 and 207. Each data point of the set of data points P1, P2 and P3 is indicative of the depth ‘D2’ of the corresponding point P3 on the worn surface portion 214 relative to the surface 210.

At step 508, the method 500 includes determining the maximum depth ‘D2’ of the worn surface portion 214 based on the set of data points P1, P2, and P3. At step 510, the method 500 includes comparing the maximum depth ‘D2’ of the worn surface portion 214 to the predefined tolerance limit. At step 512, the method 500 includes selecting the camshaft lobes of the sets 201, 203, 205 and 207 for a remanufacturing process if the maximum depth ‘D2’ of the worn surface portion 214 for each of the measured camshaft lobes is less than or equal to the predefined tolerance limit.

### INDUSTRIAL APPLICABILITY

The present disclosure relates to the system 300 and the method 500 of inspecting the camshaft 202 having the worn surface portion 214 of the camshaft lobes of the camshaft 202. The system 300 includes the laser scanning device 304 which inspects the worn surface portion 214 and may facilitate the operator to decide whether the camshaft 202 may be remanufactured based on the depth ‘D2’ with reference to the predefined tolerance limit. The system 300 and the method 500 may further facilitate accurate and quick inspection of the surface 210 of the camshaft 202, in order for repairable camshaft lobes to be repaired and certain camshafts discarded if any one of the lobes is determined to be beyond tolerance limits. It may also be contemplated that the system 300 and the method 500 of the present invention may be used to inspect the bearing portions 214 of the camshaft 202.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A method of inspecting a camshaft for worn surfaces of camshaft lobes, the camshaft having an axis of rotation, the method comprising:
providing a laser scanning device at a predetermined distance from the worn surface of each of the camshaft lobes, wherein the laser scanning device is configured to scan and gather data related to the worn surface;
moving the laser scanning device along a reference axis parallel with the axis of rotation of the camshaft and repeating the scanning for each of the camshaft lobes of the camshaft;
generating a set of data points for each of the camshaft lobes, via the laser scanning device, wherein each data point of the set of data points is indicative of a depth of a corresponding point on the worn surface relative to a reference surface;
determining a maximum depth of the worn surface based on the set of data points;
comparing the maximum depth of the worn surface to a predefined tolerance limit; and
selecting the camshaft lobes for a remanufacturing process if the maximum depth of the worn surface for each measured camshaft lobe is less than or equal to the predefined tolerance limit.
